(19) United States
(12) Patent Application Publication
(10) Pub. No.: US 2010/0122263 A1
(43) Pub. Date: May 13, 2010

(54) METHOD AND DEVICE FOR MANAGING THE USE OF A PROCESSOR BY SEVERAL APPLICATIONS, CORRESPONDING COMPUTER PROGRAM AND STORAGE MEANS

(75) Inventors: Thierry Didi, Paris (FR); Jacques Montes, Le Perreux-Sur-Marne (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: SIERRA WIRELESS, Issy-Les-Moulineaux Cedex (FR)

(21) Appl. No.: 12/595,716

(22) PCT Filed: Apr. 14, 2008
(86) PCT No.: PCT/EP08/54510

§ 371 Date: Nov. 13, 2009

(30) Foreign Application Priority Data
Apr. 13, 2007 (FR) 0702708

(51) Int. Cl. G06F 9/48

(52) U.S. Cl. 718/107

(57) ABSTRACT

A method of managing processor usage time includes: associating each application with a slice of the processor time and with a first or second class; and managing the processor time as a function of the processor time slices and classes. The processor time slice associated with an application of the first class is reserved for the application even if the application does not use it fully. An application of the second class has priority for using the processor during its associated time slice, wherein if part of the associated time slice is not used by the application, the unused part may be used by another application of the second class, the application being able to use more than its associated time slice by using an unused part of a time slice associated with another application of the second class or a part of a time slice associated with no application.

### CROSS-REFERENCE TO RELATED APPLICATIONS

This Application is a Section 371 National Stage Application of International Application No. PCT/EP2008/054510, filed Apr. 14, 2008 and published as WO 2008/125664 on Oct. 23, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of computers comprising a single processor (also called single processor computers) and an operating system permitting several applications (also called programs) to be executed by this processor.

By computer, it is meant any machine which permits information to be processed according to sequences of instructions or programs, especially including compact machines such as PDAs (Personal Digital Assistants), radio-communication devices or circuits or autonomous electronic equipment (spatial probes, robots, vehicle computers, etc.).

Each application comprises one or more processes, and permits one or several tasks to be executed. Indeed, each process comprises a series of elementary instructions (called threads) required to execute the task. In the case where an application permits several tasks to be executed, each task may be associated to a priority level within the application.

More precisely, the disclosure concerns a technique for managing, by an operating system, the time that a single processor is used by at least two applications.

In the following description, the term “processor time” will be used for the time that a processor is used.

The disclosure especially applies, but not exclusively, to the case wherein the operating system is a RTOS (real time operating system), which is to say wherein at least one of the applications must be executed in real time.

### BACKGROUND OF THE DISCLOSURE

It is common for several processes (and consequently several tasks) to be executed in parallel on a single processor computer. The operating system is then called multi-task. Indeed, one of the roles of the operating system (and more precisely the operating system core scheduler) is to permit several processes to be executed and to use the processor optimally from the user's point of view. Usually, to give the illusion that several processes are processed simultaneously, the scheduler uses context and scheduling switching notions.

Two types of real time operating systems may be distinguished: those which use priority scheduling and those which use time sharing scheduling or time slicing scheduling.

In the case where a real time operating system uses priority scheduling, each task is allocated a priority and may be in one of the five following states: dormant (not scheduled), executable (ready to be executed but does not have use of the processor at that time), active (its instructions are currently being executed by the processor), blocked (its execution is suspended until it receives a signal or the availability of a resource) and interrupted (it executes an interruption routine programmed by the user). The scheduler always allocates the processor to the task that is not dormant or blocked and which has the highest priority. If it is possible that several tasks with the same priority become active, several strategies may be envisaged: either the execution of limited sequences of instructions of all of these tasks is alternated (called time slicing as each task has successive slices of time), or the processor is randomly allocated to one of these tasks, or this situation is avoided by forbidding the same priority to be given to two distinct tasks. When a task T2 that has a higher priority than a task T1 that is active changes from the blocked state to the executable state, there are two mechanisms that may be used:
either the task T2 remains suspended (executable state) until the completion of T1. The scheduler is not pre-emptive in this case. The disadvantage is that the response time of a task is affected by the behaviour of tasks with lower priorities;
or the operating system switches task T1 to the executable state and allocates the processor to task T2. The scheduler is in this case pre-emptive.

In the case where a real time operating system that uses time slicing to schedule the tasks, a Round-Robin type scheduling algorithm us used: it allocates slices of time to each process in equal proportions, without allocating any priority to the processes.

Unfortunately, neither of the two task scheduling techniques (priority or time slicing) from the prior art mentioned above provides an optimal solution to the problem of managing the time of use of a single processor by several applications.

One disadvantage that is common to both of these techniques is that they do not allow the moments when a given application may use the processor to be defined precisely.

The task priority scheduling technique has other disadvantages which arise from the fact that it manages at task level, and not at application level:
a task of a first application may always be stopped (it then switches to an executable state) given that a task with a higher priority of a second application may change to the executable state. Therefore, this first application does not have a minimum guaranteed processor time. It appears difficult to harmonise the priorities of the tasks of all of the applications, especially as it is common that the applications which are to be executed on the same processor come from different providers;

if the task with the highest priority (all applications included) causes a system crash, all of the applications (and not just the one to which the task that caused the crash belongs) are blocked and cannot use the processor. The solution that is currently proposed to resolve this problem consists of providing a watchdog mechanism that is designed to ensure that an application does not block at a specific step in the processing. This mechanism is a protection designed to reboot the system if a defined action is not executed within a given period of time.

The time slicing task scheduling technique also has a disadvantage which arises from the fact that that it manages at task level, and not at application level. It is possible to guarantee a minimum processor time per task, but it is impossible to guarantee a minimum processor time for a given application. Indeed, the processor time available to each application depends on the total number of applications executed by the processor (moreover, all of the applications do not have the same number of tasks). Whereas certain applications need more processor time than others and above all require a minimum processor time (the case for example of an emergency call application, in the event of an accident).

Another disadvantage of the time slicing task scheduling technique is that it does not use the processor time optimally. Indeed, is a task does not use the entire time slice that it has allocated to it, the unused part of this time slice cannot be allocated to another task, and is therefore lost.

### SUMMARY

In one specific embodiment of the invention, a method is proposed for the management, by an operating system, of a time of use of a single processor by at least two applications, said time of use being called processor time, said method comprising the following steps:
associating to each application a slice of said processor, said processor time slice being able to be nil;
associating to each application one of the two following classes:
a first class such that the processor time slice that is associated to said application is reserved to said application even if said application does not use it entirely, said application being not able to use more than the processor time slice that is associated to it;
a second class such that said application has priority for the processor during the processor time slice that is associated to it, if part of the processor time slice associated to said application is not used by said application then said unused part can be used by another application of said second class, said application being able to use more than the processor time slice that is associated to it by using an unused part of a processor time slice associated to another application of said second class or a part of a time slice not associated to any application; and
managing said processor time in function of the slices of processor time and classes associated to the applications.

The general principle of this embodiment thus consists of managing the processor time at the level of the applications themselves (wherein each application may comprise one or several processes, wherein each process executes a task), and not at task level.

Regardless of the class that is associated to it, each application has a minimum guaranteed processor time as a processor time slice (that may be nil) is associated to it.

Furthermore, the use of the processor time is optimised as, between applications of the second class, the parts of the slices of processor time that are unused by certain applications are re-used by other applications.

It may also be noted that this technique is transparent for the applications which are executed. It is the operating system that manages the use of the processor. The applications do not have any request to issue to use the processor.

Advantageously, said processor time is broken down into cycles, each cycle comprising a number N of time intervals, and the processor time slice associated to each application comprises a number Kᵢ of time intervals in each cycle, where 1<Kᵢ<N and i is an index relative to the application.

The duration of each time interval defines the granularity of the switching of context between applications. A short duration risks slowing down the operation of the system with, potentially, a high number of context switches between applications. A long duration does not permit fine distribution of the processor time between applications.

Advantageously, said method comprises the following step: if during a running cycle, a second class application has not used the entire duration of its Kᵢ time intervals due to the fact that it did not require the processor during X of said Kᵢ time intervals but finally requires the use of a number of time intervals greater than the number Y of time intervals remaining for said second class application, where Y=Kᵢ−X, then the number of time intervals Kᵢ is dynamically modified during at least one following cycle.

In this way, a first compensation mechanism is proposed, which permits a given application, over several cycles, to use the processor for a number of time intervals equal or close to the number of time intervals actually associated to this application.

According to one advantageous feature, said method comprises the following step: if, during a running cycle, a second class application has not used all of the duration of its Kᵢ time intervals due to the fact that it did not require the processor during X of said Kᵢ time intervals but finally requires the use of a number of time intervals greater than the number Y of time intervals remaining for said second class application, where Y=Kᵢ−X, then the duration of at least one following time cycle is dynamically modified.

Consequently a second compensation mechanism is proposed which permits a given application, over several cycles, to use the processor for a number of time intervals equal or close to the number of time intervals actually associated to this application.

Advantageously, said method comprises the following step for at least one of said applications: the association of a start instant for the processor time slice associated to said application, or a start instant for each time interval within the processor time slice associated to said application.

Consequently, it is possible to guarantee that an application will take control at certain precise moments. This is very important especially when certain applications need to be synchronised with others.

Advantageously, said method comprises the following step, for at least one second class application: the association to said application of a priority level permitting the decision to be made as to which second class application may use the processor in the case where several second class applications are eligible to use the processor.

Consequently, the decision is made beforehand as to which second class applications will have priority for the use of the processor time available due to the fact that second class applications do not use all of the slices of processor time that are associated to them.

According to one variant, a Round-Robin type algorithm is used to decide which second class application may use the processor in the case where several second class applications are eligible to use the processor. In other words, the processor time available, due to the fact that second class applications do not use all of the slices of processor time that are associated to them, is shared equally between the second class applications.

Advantageously, said method comprises a step to verify that the sum of the slices of processor time of all of the applications is lower than or equal to 100% of the application processor time, defined as the difference between said processor time and a part of said processor time used by said operating system.

In this way, a check is made that the system is correctly configured to operate in the worst situation, which is to say if each of the applications uses all of the processor time slice that is associated to it (due to the fact that it actually requires it, the case of an application that uses a lot of processor time, or if there is a bug, the case of a looping application).

In one specific embodiment of the application, said operating system is a real time operating system.

An embodiment of the present invention is particularly adapted to meet real time constraints. The time slice associated to each application that has to be executed in real time simply needs to be selected suitably.

Advantageously, at least one interruption, called an interruption of the first type, is not associated to any of said applications and is not taken into consideration in the management of said processor time.

Each interruption of the first type is therefore considered as system noise.

Advantageously, at least one interruption, called an interruption of the second type, is not associated to any of said applications and is taken into consideration in the management of said processor time in the following manner: a quantity of time is reserved for all of the interruptions of the second type, such that the sum of the slices of processor time of all of the applications is lower than or equal to 100% of said processor time less said quantity of time reserved.

Consequently, account is taken of the interruptions of the second type in the management of the processor time, but independently of the applications.

According to one advantageous feature, at least one interruption, called an interruption of the third type, is associated to at least one of said applications and is taken into consideration in the management of said processor time in the following manner:
a quantity of processor time required for said interruption of the third type is taken into consideration in the processor time slice of the application(s) associated to the interruption of the third type; and
the processor time pre-empted by said interruption of the third type on at least one other application is retroceded to at least one other application.

Consequently, the interruptions of the third type are taken into consideration in the management of the processor time, but in relation with the applications to which they are associated.

In one specific embodiment of the invention, said processor is comprised in a radio-communication circuit, and said applications comprise an application for managing a radio-communication stack and at least one customer application.

An embodiment of the invention applies especially, but not exclusively, in the case where the radio-communication circuit is an electronic radio-communication module designed to be integrated into a radio-communication device. By radio-communication devices (also called radio-communication terminals or wireless terminals), it is meant any devices or means capable of exchanging signals using a radio-communication system, fitted for example in machines or vehicles (M2M—machine to machine—and automobile markets). The electronic radio-communication module is for example a module of the WISMO (registered trade mark) family by WAVECOM (the party submitting this patent application). WAVECOM has indeed for a number of years proposed an approach which overcomes a certain number of these disadvantages, consisting of grouping together into a single module (called electronic radio-communication module) all or at least most of the functions of a digital radio-communication device. Such a module is in the form of a single housing, preferably shielded, that the manufacturers of devices may fit directly without having to take into account a multitude of components. This module is formed by a group of several components on a substrate, so that it may be installed as a single element. It comprises the essential components (especially a processor, memories and software programs) required for the operation of a radio-communication device using radio-electrical frequencies. There are consequently no longer any complex design steps or validation of the design. It is sufficient to reserve the space required by the module. Such a module can therefore easily, quickly and optimally incorporate all of the components into wireless terminals (mobile telephones, modems or any other device using a wireless standard).

In one variant of application of an embodiment of the invention, the radio-communication circuit is not a radio-communication module in the above sense but a printed circuit that is part of a radio-communication device and onto which a set of electronic components are installed, whose purpose is to provide the various radio-communication functions required, from receiving an RF signal to the generation of an audible signal (in the case of a radio-telephone) and inversely.

In another embodiment, the invention relates to a computer program product that may be downloaded from a communication network and/or saved onto a support that may be read by a computer and/or executed by a processor, wherein this computer program product comprises program code instructions for the implementation of above-mentioned method, when said program is executed on a computer.

In another embodiment, the invention relates to storage means that may be totally or partially removable, that may be read by a computer, storing a set of instructions that may be executed by said computer to implement above-mentioned method.

In another embodiment, the invention relates to a device comprising an operating system permitting a time of use of a single processor by at least two applications to be managed, said time of use being called processor time. This device comprises:
means for associating to each application a slice of said processor time, said processor time slice being able to be nil;
means for associating to each application one of the two following classes:
a first class such that the processor time slice that is associated to said application is reserved to said application even if said application does not use it entirely, said application being not able to be use more than the processor time slice that is associated to it;
a second class such that said application has priority for the processor during the processor time that is associated to it, if part of the processor time slice associated to said application is not used by said application then said unused part can be used by another application of said second class, said application being able to use more than the processor time slice that is associated to it by using an unused part of a processor time slice associated to another application of said second class or a part of a time slice not associated to any application; and
means for managing said processor time in function of the slices of processor time and classes associated to the applications.

More generally, the device comprises means for implementing the processor time management method as described above (in any of its embodiments).

### BRIEF DESCRIPTION OF THE DRAWINGS

Other features and advantages of embodiments will become clearer upon reading the following description, provided by way of example and non-restrictively (all if the embodiments of the invention are not restricted to the features and advantages of the embodiments described below) and the appended drawings, in which:

FIG. 1 presents an organisation chart of a specific embodiment of the method according to an embodiment of the invention;

FIG. 2 illustrates a first example of the sharing of processor time between three applications associated to the CTR class, according to one specific embodiment of the invention;

FIG. 3 illustrates a second example of the sharing of processor time between three applications, one associated to the CTR class and the other two associated to the VTR class, according to one specific embodiment of the invention;

FIG. 4 illustrates an example of tables of tasks and interruption managers associated to three applications, as well as the sharing of the processor time between these three applications; and

FIG. 5 illustrates a third example of the sharing of the processor time between three applications associated to the VTR class according to one specific embodiment of the invention.

### DETAILED DESCRIPTION OF ILLUSTRATIVE EMBODIMENTS

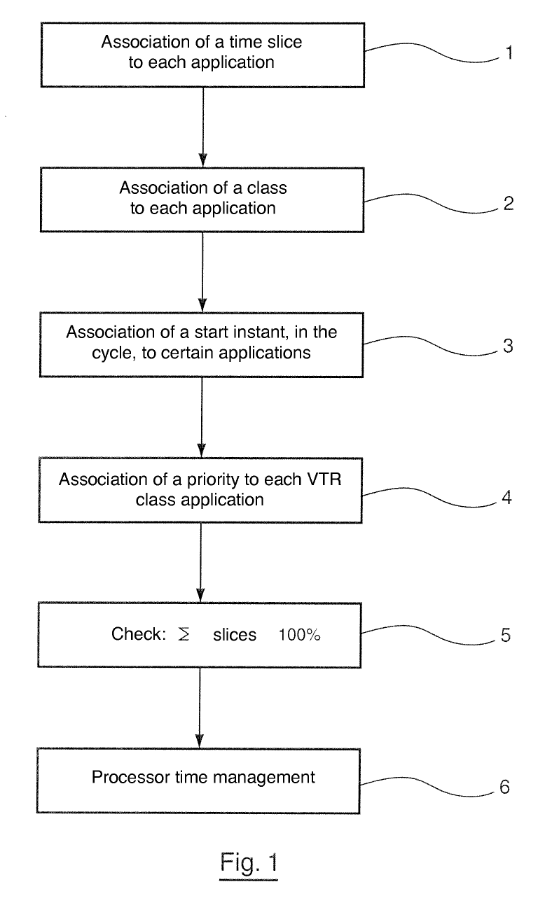

Now in relation to FIG. 1, a specific embodiment of the method according to the invention will be presented for managing, by an operating system, a time of use of a single processor (called processor time below) by at least two applications.

In a step 1, each application is associated to a processor time slice (or CPU time slice). To achieve this, a periodic timer is used for example which divides the processor time into cycles, wherein each cycle comprises a number N of time intervals (called AST below, Application Scheduling Tick). The processor time slice associated to each application comprises a number Ki of time intervals in each cycle, where 1<Kᵢ<N, and is an index relative to the application. Each time slice is thus composed of the recurrence of a certain number of time intervals within a cyclic structure comprising a determined number of time intervals. For example, if a time interval has a duration of 20 ms and if a cycle comprises 5 time intervals, an application may be associated to a time slice comprising 2×20 ms every 100 ms.

In a step 2, each application is associated to one of the two following application classes:
CTR (Constant Time Rate) class, such that the processor time slice that is associated to a CTR application is reserved to this application even if it does not use it entirely (which is to say even if it has no software activity during this time slice). A CTR application cannot use more than the processor time slice that is associated to it, even if the processor is not used;
VTR (Variable Time Rate) class, such that a CTR application has priority to use the processor during the time slice that is associated to it. If part of the processor time slice associated to a VTR application is not used by it, then it may be used by another VTR application. A VTR application may use more than the processor time slice that is associated to it, by using an unused part of a processor time slice associated to another VTR application or part of a time slice associated to no applications.

In a step 3, an execution start instant may be associated to at least one application. This start instant is for example defined by the number (rank in the cycle previously mentioned) of the first of the time intervals allocated to this application. If the above example is used (time interval of 20 ms and cycle of 5 time intervals), the time slice comprising 2×20 ms every 100 ms starts for example, at each cycle, with the first of the five cycle intervals.

In a step 4, each of the VTR applications (or only some of them) is associated to a priority level. This priority is used to decide which VTR application may use the processor in the case where several VTR applications are eligible to use the processor (when the latter is idle).

At the end of these steps 1 to 4, all of the information associated to the applications may be stored in a memory by the operating system, for example in the form of the table below (the number of applications is noted M). This table is called below ART (Applications Rate Table).

| | | AST | Priority (if VTR | Start date (AST |
|---|---|---|---|---|
| Application | Class | number | application) | number) |
| Application n^{o} 1 | C₁ | K₁ | P₁ | X |
| . . . | . . . | . . . | . . . | . . . |
| Application n^{o} M | C_{M} | K_{M} | P_{M} | Y |

In this way for example, the application n^{o} 1 is associated to class C₁ (CTR or VTR), at a processor time slice comprising K₁ time intervals per cycle and starting at the Xth time interval of each cycle, and with a priority of P₁ (if it is a VTR application).

In a step 5, the operating system checks that the sum of the processor time slices of all of the applications is lower than or equal to 100% of an application processor time, defined as the difference between the total processor time and a part of this total processor time that is used by the operating system. In the above mentioned example, this means checking that the total accumulated number of time intervals associated to the various applications is not greater than the number of time intervals in a cycle.

In a step 6, the operating system manages the processor time in function of all of the information associated to the applications (which is to say in function of the content of the above-mentioned ART).

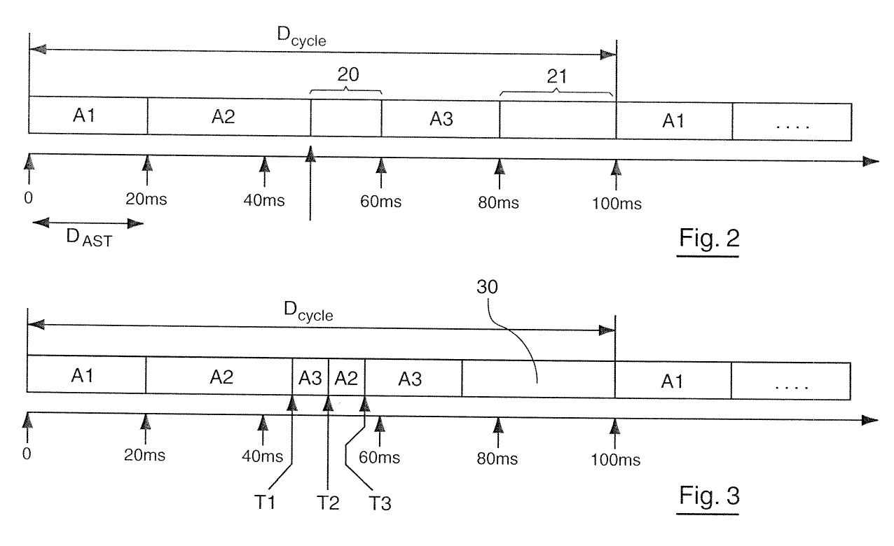

FIG. 2 illustrates a first example of processor time sharing, which has the following ART:

| | | | Priority (if VTR | Start date (AST |
|---|---|---|---|---|
| Application | Class | AST number | application) | number) |
| A1 | CTR | 1 (20 ms) | Not applicable | 1^{st} AST |
| A2 | CTR | 2 (40 ms) | Not applicable | 2^{nd} AST |
| A3 | CTR | 1 (20 ms) | Not applicable | 4^{th} AST |

It is supposed that each time interval (AST) has a duration (D_{AST}) of 20 ms and that a cycle comprises 5 time intervals, which is to say has a duration of (D_{cycle}) of 100 ms.

It may be seen in FIG. 2 that the first time interval is reserved for application A1, which uses it entirely.

The second and third time intervals are reserved for application A2, which does not use them entirely. However the part (reference 20) not used by the application A2 may not be used by another application as the application A2 is a CTR class application.

The fourth time interval is reserved for the application A3 which uses it entirely.

As the fifth time interval (reference 21) cannot be used by any of the applications A1, A2 and A3 (as they are all CTR class), the processor can switch to low consumption mode. This fifth time interval is available in the case of a modification to the set of applications sharing the processor time.

FIG. 3 illustrates a second example of processor time sharing, which has the following ART:

| | | | Priority (if VTR | Start date (AST |
|---|---|---|---|---|
| Application | Class | AST number | application) | number) |
| A1 | CTR | 1 (20 ms) | Not applicable | 1^{st} AST |
| A2 | VTR | 2 (40 ms) | Pmax | Not specified |
| A3 | VTR | O (0 ms) | Pmin | Not applicable |

It is again supposed that each time interval (AST) has a duration (D_{AST}) of 20 ms and that a cycle comprises 5 time intervals, which is to say has a duration of (D_{cycle}) of 100 ms.

It may be seen in FIG. 3 that the first time interval is reserved for application A1, which uses it entirely.

The second and third time intervals are reserved for application A2, which does not use them entirely. From the instant reference T1, the application A2 no longer needs the processor and given that this concerns a VTR class application, it can hand the access over to another VTR class application: the application A3 in this case. At the instant reference T2, situated before the end of the third time interval, an external event intervenes for application A2, which takes back the access as the second and third time intervals are reserved for it. At the instant reference T3, situated before the end of the third time interval, the application A2 once again no longer requires the processor and thus hands over access to the application A3.

The fourth and fifth time intervals are not reserved to any applications but may be used by VTR class applications, which is to say the applications A2 and A3 (application A2 has priority over application A3, in the case where they both wish to use the processor at the same time). In the example illustrated in FIG. 3, part (reference 30) of the fourth and fifth time intervals is not used.

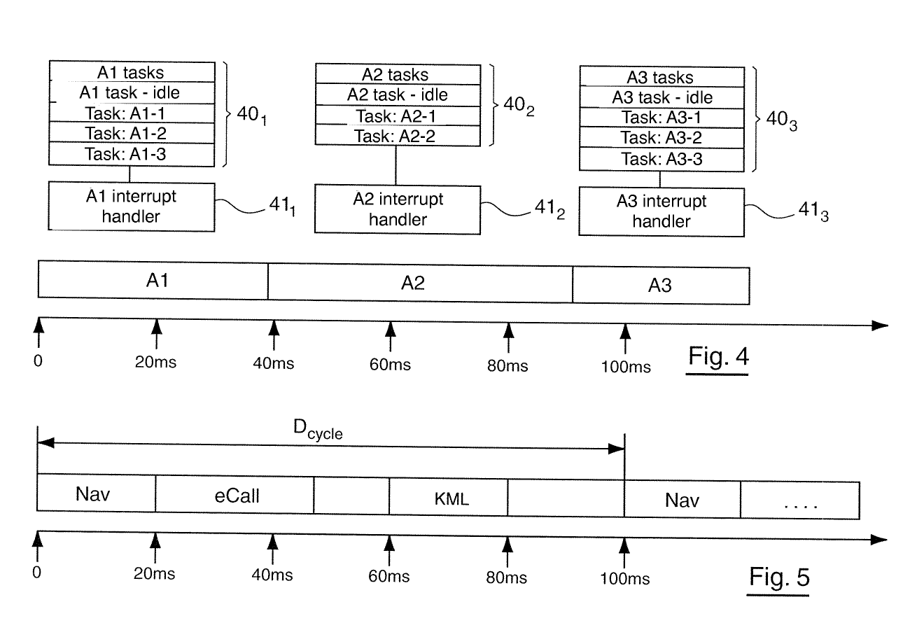

FIG. 4 is presented with an example of tables of tasks and interruption managers associated to three applications, as well as the sharing of the processor time between these three applications.

Each application (A1, A2, A3 respectively) is associated to:
a table of tasks (40₁, 40₂ and 40₃ respectively) comprising:
an IDLE task (Task A1—idle, Task A2—idle, Task A3—idle respectively) which permits the inactivity of the application concerned to be detected and makes switching between applications possible;
classic tasks (for example Tasks A1-1, A1-2 and A1-3 for application A1); and
an interrupt handler (41₁, 41₂ and 41₃ respectively) or ISR (Interrupt Service Routine).

A specific embodiment of the invention will now be described. Each application comprises a set of real time tasks, wherein each of these tasks is allocated a priority level (between 0 and 100 for example). The real time operating system configures the duration of a time interval (20 ms for example). The ART stores the information associated to each application: the class of this application (CTR or VTR), the number of time intervals allocated to this application, the priority level of this application (for VTR applications only) (not to be confused with the priority levels of the tasks within this same application) and, possibly, the start instant of this application in the cycle (which is to say the rank, in the cycle, of the first time interval allocated to this application).

When started up, the operating system:
creates a task table for each application, with its corresponding tasks (see FIG. 4);
starts the first time interval;
launches the first application of the ART, by loading the corresponding task table;
schedules the tasks in function of their state and priority.

At the end of each time interval, the real time operating system checks that the duration allocated to the active application running has been reached. In the case of a positive check, then it launches the next application (by loading the corresponding task table).

When the application running enters its IDLE task:
if the application is of the CTR class, then no switching of application takes place (the time slice is not pre-emptive);
if the application is of the VTR class, then the operating system:
memorises the proportion of its processor time slice that this application has already used;
checks if another VTR application is waiting for the processor. If several VTR applications are eligible, the one with the highest priority is chosen);
if an application is found, it is launched (by loading the corresponding table of tasks).

A watchdog type mechanism is implemented for example to detect if an application does not return to the idle state after a determined number of cycles. Indeed, such a situation may be normal (for example if it is an application that uses the processor intensively) or not (the application has entered an infinite loop). When such a situation is detected, at least one of the following actions is implemented: notification to the application (reminder) that it has spent more than a predefined quantity of time before switching to the IDLE task, re-initialisation of the application or re-initialisation of the entire system.

If a first application of the VTR class does not require the processor during one of its time intervals (which is to say one of the time intervals that are associated to it), the processor may be used by another VTR class application. If the first application finally requires the processor before the end of its time interval, it takes back the access and may use the processor. Nevertheless, at the end of the cycle running, the first application may not have the processor time that was reserved for it during this cycle. At least one of the following compensation mechanisms is for example implemented:
for at least one following cycle, dynamic modification of the number of time intervals associated to the first application (in steps of +10% or −10% for example);
dynamic modification of the duration of at least one following cycle (in steps of +10% or −10% for example).

Now in relation to FIG. 5, a third example of processor time sharing is presented, which ahs the following ART:

| | | AST | Priority (if VTR | Start date (AST |
|---|---|---|---|---|
| Application | Class | number | application) | number) |
| A1 (eCall) | CTR | 1 (20 ms) | P1 (medium) | Not specified |
| A2 (Nav) | VTR | 1 (20 ms) | P2 (min.) | 1^{st} AST |
| A3 (Hands-free | VTR | 3 (60 ms) | P3 (max.) | Not specified |
| kit) | | | | |

It is again supposed that each time interval (AST) has a duration (D_{AST}) of 20 ms and that a cycle comprises 5 time intervals, which is to say has a duration of (D_{cycle}) of 100 ms. It is also supposed that allocating a time interval of 20 ms every 100 ms to an application is equivalent to providing a capacity of use to the processor of 20 ms.

The application A1 is an emergency call application, for example the “eCall” application. In the case of an accident, the radio-communication device which executes the “eCall” application and which is fitted inside a vehicle sends an emergency call to the most suitable emergency call centre, and at the same time sends a certain number of items of data relative to the vehicle (in particular its precise location). The emergency call may be triggered manually by the occupants of the vehicle or automatically in the case of a serious accident, by means of sensors in the vehicle. The mains constraints of the “eCall” application are:
use of 5 MIPS in normal mode, and 15 MIPS during an emergency call;
protection against bugs in other applications that are part of the same radio-communication device (it must be able to be executed in all cases); and
reaction to an accident in less than 1 second.

These constraints are respected by the allocation of a time interval of 20 ms every 100 ms, which is equivalent to 20 MIPS.

The A2 application is a GPS (Nav) application which for example sends via a Bluetooth wireless connection messages which comply with the NMEA-0183 (National Marine Electronics Association) application. Its main constraints are:
execution in less than one second (during 100 ms); and
use of at least 1 MIPS.

These constraints are respected by the allocation of a time interval of 20 ms every 100 ms, which is the equivalent of 20 MIPS. Furthermore, the fact that the time interval allocated is the first of the cycle ensures that NMEA messages may be sent precisely every second (which is to say every ten cycles).

The A3 application is a hands-free (KML) application, which for example may implement:
Automatic speech recognition (ASR) and speech synthesis (Text to Speech, TTS); and
establish a GSM call, which uses 2 MIPS.

The main constraint of the A3 application is that the ASR has to translate a sentence in less than two seconds for good human interaction, and to do so must dispose of at least 60 MIPS when it is executed.

This constraint is respected by the allocation of three time intervals (i.e. 60 ms in total) every 100 ms (which is the equivalent of 60 MIPS) and the maximum priority level. In this way, the speech recognition (ASR) functions and speech synthesis (TTS) may use all of the processor time that is not used by the other applications. In nominal mode, the eCall application uses 15 MIPS in case of emergency and the Nay application uses 1 MIPS. Therefore there are 84 MIPS remaining for the ASR and TTS functions. In the worst case, the eCall and Nay applications have entered an infinite loop, and each block 20 MIPS. There are still however 60 MIPS remaining for the ASR and TTS functions.

Furthermore, various strategies may be envisaged to manage the interruptions. These various strategies may be applied simultaneously to different interruptions. A reminder is made that an interruption is the call of a special routine called ISR (Interrupt Service Routine).

Strategy n^{o} 1: an interruption of the first type is not associated to any of the applications (either because it serves several applications, or because it uses a very small quantity of time, or even for any other choice of design) and is not taken into consideration in the processor time management. It is considered as system noise.

Strategy n^{o} 2: an interruption of the second type is not associated to any of the applications (either because it serves several applications, or because it uses a very small quantity of time, or even for any other choice of design) but it is taken into consideration in the processor time management. A quantity of time is reserved for all of the interruptions of this second type, so that the sum of the processor time slices of all of the applications is lower than or equal to 100% of the processor time less the quantity of time reserved. It is supposed that this quantity of time reserved is redistributed equally between all of the applications. Consequently, all of the applications are statistically allocated their respective time slices.

Strategy n^{o} 3: an interruption of a third type is associated to one or several applications and is taken into consideration in the processor time management in the following manner:
a quantity of processor time required for the interruption of the third type is taken into consideration in the processor time slice of the application(s) associated to the interruption of the third type; and
the processor time pre-empted by this interruption of the third type on at least one other application is transferred to at least one other application (unless this at least one other application is that to which the interruption of the third type is associated).

In one specific embodiment, the processor is shared between an application for managing a radio-communication stack (GSM stack for example) and at least one customer application. This especially applies in the case where the processor is part of a radio-communication circuit, for example an electronic radio-communication circuit designed to be incorporated into a radio-communication device. This electronic radio-communication device is for example a module of the WISMO (registered trade mark) family by WAVECOM (the party submitting this patent application).

In this case, the radio-communication stack is considered as an application, to which various items of information may be associated, such as for example: class (VTR or CTR), the number of time intervals, the priority level (for VTR applications only) and, possibly, the start instant of this application in the cycle.

The radio-communication stack typically has an interruption (ISR) that is a heavy consumer of processor time. This interruption is managed using one of the three strategies mentioned. In one specific embodiment of the invention, the strategy n^{o} 3 is adopted: the interruption is associated with the stack itself, and the processor time consumed by this interruption is restored to the applications to which this time was preempted.

At least one exemplary embodiment of the disclosure provides a technique for managing, used by an operating system, the time of use of a single processor by at least two applications, wherein this technique permits a minimum processor time to be guaranteed for each of the applications, even if one of the applications is blocked.

At least one embodiment provides such a technique permitting the use of the processor time to be optimised.

At least one embodiment provides such a technique that is simple to use and inexpensive.

At least one embodiment provides such a technique that is transparent for the applications when they are executed.

Although the present disclosure has been described with reference to one or more examples, workers skilled in the art will recognize that changes may be made in form and detail without departing from the scope of the disclosure and/or the issued claims.

1-15. (canceled)

16. A method of managing, by an operating system, a time of use of a single processor by at least two applications, said time of use being called application processor time, wherein the method comprises the following steps:
in a table, associating to each application a slice of said application processor time, said application processor time slice being able to be nil;
in said table, associating to each application one of the two following classes of application:
a first class of application such that the application processor time slice that is associated to said application is reserved to said application even if said application does not use the slice entirely, said application being not able to use more than the application processor time slice that is associated to that application;
a second class of application such that said application has priority for the processor during the application processor time slice that is associated to that application, if a part of the application processor time slice associated to said application is not used by said application then said unused part can be used by another application of said second class of application, said application being able to use more than the application processor time slice that is associated to that application by using an unused part of an application processor time slice associated to another application of said second class of application or a part of a time slice not associated to any application; and
managing said application processor time as a function of the slices of application processor time and classes of application associated to the applications in said table.

17. The method according to claim 1, wherein said application processor time is broken down into cycles, each cycle comprising a number N of time intervals, and wherein the application processor time slice associated to each application comprises a number Kᵢ of time intervals in each cycle, where 1≦Kᵢ<N and i is an index relative to the application.

18. The method according to claim 2, wherein the method comprises the following step: if during a running cycle, a second class application has not used the entire duration of its Kᵢ time intervals due to the fact that the second class application did not require the processor during X of said Kᵢ time intervals but finally requires the use of a number of time intervals greater than the number Y of time intervals remaining for said second class application, where Y=Kᵢ−X, then increasing dynamically the number of time intervals Kᵢ during at least one following cycle.

19. The method according to claim 2, wherein the method comprises the following step: if during a running cycle, a second class application has not used the entire duration of its Kᵢ time intervals due to the fact that the second class application did not require the processor during X of said Kᵢ time intervals but finally requires the use of a number of time intervals greater than the number Y of time intervals remaining for said second class application, where Y=Kᵢ−X, then increasing dynamically the duration of at least one following time cycle.

20. The method according to claim 1, wherein the method comprises the following step, for at least one of said applications: associating, in said table, a start instant for the application processor time slice associated to said application, or a start instant for each time interval comprised in the application processor time slice associated to said application.

21. The method according to claim 1, wherein the method comprises the following step, for at least one second class application: associating, in said table, to said application a priority level permitting the decision to be made as to which second class application may use the processor in the case where several second class applications are eligible to use the processor.

22. The method according to claim 2, wherein the method comprises a step to verify that the sum of the slices of application processor time of all of the applications is lower than or equal to 100% of a maximal value, defined as the difference between a total processor time and a part of said total processor time used by said operating system.

23. The method according to claim 1, wherein said operating system is a real time operating system.

24. The method according to claim 1, wherein at least one interruption, called an interruption of the first type, is not associated to any of said applications and is not taken into consideration in the management of said application processor time.

25. The method according to claim 1, wherein at least one interruption, called an interruption of the second type, is not associated to any of said applications and is taken into consideration in the management of said application processor time in the following manner: a quantity of time is reserved for all of the interruptions of the second type, such that the sum of the slices of application processor time of all of the applications is lower than or equal to 100% of said application processor time less said quantity of time reserved.

26. The method according to claim 1, wherein at least one interruption, called an interruption of the third type, is associated to at least one of said applications and is taken into consideration in the management of said application processor time in the following manner:
a quantity of application processor time required for said interruption of the third type is taken into consideration in the application processor time slice of the application(s) associated to the interruption of the third type; and
the application processor time pre-empted by said interruption of the third type on at least one other application is retroceded to at least one other application.

27. The method according to claim 1, wherein said processor is comprised in a radio-communication circuit, and said applications comprise an application for managing a radio-communication stack and at least one customer application.

28. Storage device, that may be read by a computer, storing a set of instructions executable by said computer to implement a method of managing, by an operating system, a time of use of a single processor by at least two applications, said time of use being called application processor time, wherein said set of instructions performs the followings steps when the set of instructions is executed:
in a table, associating to each application a slice of said application processor time, said application processor time slice being able to be nil;
in said table, associating to each application one of the two following classes of application:
a first class of application such that the application processor time slice that is associated to said application is reserved to said application even if said application does not use the slice entirely, said application being not able to use more than the application processor time slice that is associated to that application;
a second class of application such that said application has priority for the processor during the application processor time slice that is associated to that application, if a part of the application processor time slice associated to said application is not used by said application then said unused part can be used by another application of said second class of application, said application being able to use more than the application processor time slice that is associated to that application by using an unused part of an application processor time slice associated to another application of said second class of application or a part of a time slice not associated to any application; and
managing said application processor time as a function of the slices of application processor time and classes of application associated to the applications in said table.

29. A device comprising an operating system permitting a time of use of a single processor by at least two applications to be managed, said time of use being called application processor time, wherein the operating system comprises:
means for associating, in a table, to each application a slice of said application processor time, said application processor time slice being able to be nil;
means for associating, in said table, to each application one of the two following classes of application:
a first class of application such that the application processor time slice that is associated to said application is reserved to said application even if said application does not use the slice entirely, said application being not able to use more than the application processor time slice that is associated to that application;
a second class of application such that said application has priority for the processor during the application processor time that is associated to that application, if a part of the application processor time slice associated to said application is not used by said application then said unused part can be used by another application of said second class of application, said application being able to use more than the application processor time slice that is associated to that application by using an unused part of an application processor time slice associated to another application of said second class of application or a part of a time slice not associated to any application; and
means for managing said application processor time as a function of the slices of application processor time and classes of application associated to the applications in said table.
